(19) United States
(12) Patent Application Publication
(10) Pub. No.: US 2019/0106052 A1
(43) Pub. Date: Apr. 11, 2019

(54) Pedestrian Warning System

(71) Applicant: Jose Delgado, San Pedro, CA (US)

(72) Inventor: Jose Delgado, San Pedro, CA (US)

(21) Appl. No.: 16/156,963

(22) Filed: Oct. 10, 2018

Related U.S. Application Data
(60) Provisional application No. 62/570,647, filed on Oct. 10, 2017.

(51) Int. Cl. B60Q 1/46; B60Q 1/50; B60Q 1/52; G08G 1/005

(52) U.S. Cl. CPC B60Q 1/46; G08G 1/005; B60Q 1/525; B60Q 1/503

(57) ABSTRACT

A pedestrian warning system for use with an automobile structured and arranged to allow a driver of an automobile to signal to other drivers of automobiles in the vicinity thereof that there may be pedestrians present in the vicinity thereof and to drive cautiously.

### CROSS-REFERENCE TO RELATED APPLICATION

The present application is related to and claims priority from prior provisional application Ser. No. 62/570,647, filed Oct. 10, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of warning devices and more specifically relates to a pedestrian warning system for use with an automobile structured and arranged to allow a driver of an automobile to signal to other drivers of automobiles in the vicinity thereof that there may be pedestrians present in the vicinity thereof and to drive cautiously.

### 2. Description of the Related Art

Raising the bar on pedestrian safety in intersection crosswalks and sharpening driver awareness of pedestrians in street crossings are important nationwide objectives. To illustrate the seriousness of this problem, it is worth noting that in one city alone, Washington, D.C., at least nine pedestrians were killed in pedestrian-vehicle accidents during a recent month. A recent article in the local paper reported on seven pedestrians who had been killed or injured during rush hour on a single day. It is important to remember that pedestrians are frequently not at fault when struck by automobiles. Data also shows that almost half of all pedestrian injuries occur while the pedestrian is crossing at the intersection in the crosswalk. To increase safety for pedestrians when using a crosswalk, and to significantly reduce the number of pedestrian injuries and fatalities that occur each year, Mr. Jose Delgado has conceptually developed an invention/product which he has designated as the Pedestrian Warning System.

Various attempts have been made to solve problems found in warning devices art. Among these are found in: U.S. Pat. No. 7,489,236 to Faustino V. Chavarria; U.S. Pat. No. 5,905,434 to Paul J. Steffan et al; and U.S. Pat. No. 5,537,091 to Harold L. Hull et al. This prior art is representative of warning devices for notifying drivers in a vehicle of pedestrians crossing.

Ideally, a pedestrian warning system should be user-friendly and safe in-use and yet would operate reliably and be manufactured at a modest expense. Thus, a need exists for a molding system for forming a pedestrian warning system for use with an automobile structured and arranged to allow a driver of an automobile to signal to other drivers of automobiles in the vicinity thereof that there may be pedestrians present in the vicinity thereof and to drive cautiously and to avoid the above-mentioned problems.

### BRIEF SUMMARY OF THE INVENTION

In view of the foregoing disadvantages inherent in the known of warning devices art, the present invention provides a novel Pedestrian Warning System for use with an automobile. The general purpose of the present invention, which will be described subsequently in greater detail is to provide a pedestrian warning system for use with an automobile structured and arranged to allow a driver of an automobile to signal to other drivers of automobiles in the vicinity thereof that there may be pedestrians present in the vicinity thereof and to drive cautiously.

A pedestrian warning system for use with an automobile, comprising: an electronic sign and a control member. The electronic sign comprises: a main body; at least one electric light; a power source; and a receiver. The main body includes: a front panel and at least one attachment member. Wherein the front panel is formed of from a translucent material. Wherein the front panel includes indicia thereon adapted to warn drivers of other automobiles that pedestrians may be present and to be cautious while driving. Wherein the at least one attachment member is adapted to releasably attach the electronic sign to a support surface of the automobile. Wherein the main body forms an interior volume.

Wherein the at least one electric light is located within the interior volume and is adapted to illuminate the front panel. Wherein the power source is electrically connected to the at least one electric light and is adapted to provide electric power to the at least one electric light. Wherein the receiver is located within the interior volume, is electrically connected to the power source and to the at least one electric light, and is adapted to receive electronic signals from a transmitter.

The control member includes: a main body including at least one attachment member; a transmitter; and a power source. Wherein the at least one attachment member is adapted to releasably attach the control member to a support surface of the automobile. Wherein the main body forms an interior volume. Wherein the transmitter is located is located within the interior volume of the main body of the control member and is adapted to send electronic signals to the receiver of the electronic sign. Wherein the transmitter is adapted to turn on and off the at least one electric light of the electric sign. Wherein the power source is electrically connected to the transmitter and is adapted to provide electric power to the transmitter.

Wherein the pedestrian warning system is adapted to allow a driver of an automobile to signal to other drivers of automobiles in the vicinity thereof that there may be pedestrians present in the vicinity thereof and to drive cautiously.

The present invention holds significant improvements and serves as a Pedestrian Warning System for use with an automobile. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Pedestrian Warning System for use with an automobile, constructed and operative according to the teachings of the present invention.

FIG. 1 shows a perspective view illustrating an electronic sign of a Pedestrian Warning System for use with automobile according to an embodiment of the present invention.

FIG. 2 is a perspective view illustrating the electric sign adapted to be releasably connected to an interior surface of rear window of automobile of the of the Pedestrian Warning System according to an embodiment of the present invention of FIG. 1.

FIG. 3 is a perspective view illustrating the electric sign adapted to be releasably connected to a tailgate of the of the Pedestrian Warning System according to an embodiment of the present invention of FIG. 1.

FIG. 4 is a perspective view illustrating a control member adapted to be releasably connected to an interior surface of dashboard of an automobile of the Pedestrian Warning System according to an embodiment of the present invention of FIG. 1.

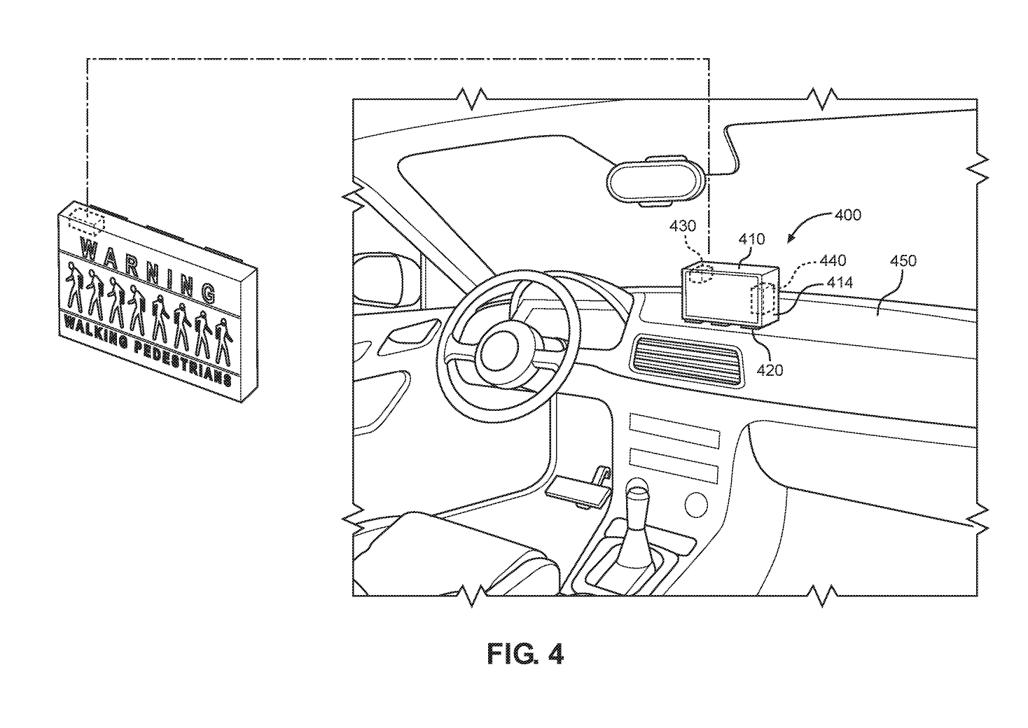

The various embodiments of the present invention will hereinafter be described in conjunction with the appended drawings, wherein like designations denote like elements.

### DETAILED DESCRIPTION

As discussed above, embodiments of the present invention relate to a warning device and more particularly to a pedestrian warning system for use with an automobile structured and arranged to allow a driver of an automobile to signal to other drivers of automobiles in the vicinity thereof that there may be pedestrians present in the vicinity thereof and to drive cautiously.

Generally speaking, the Pedestrian Warning System comprises a specially designed device structured and arranged to a practical means of promoting awareness of the dangers faced by those who are attempting to navigate crosswalks and intersections.

The Pedestrian Warning System would take the form of a sign installed in automotive vehicles, offering a highly visible means of spreading the message. Provided as an aftermarket product or preferably installed onto vehicles at point of manufacture, the Pedestrian Warning System would be positioned in the rear window of the vehicle and connected to a remote transmitter also located in the automobile. Universal in design to accommodate cars, SUVs, trucks, and vans, each Pedestrian Warning System sign would contain dimensions of approximately four inches (4″) in length, six inches (6″) in width, and one-half inch (0.5″) in depth. The electrical components of the Pedestrian Warning System could consist of a series of red or white light emitting diodes (LEDs) and resistors (500 ohms), along with an AWG cable. Protected by a cylindrical plastic casing and reflecting film, the Pedestrian Warning System would, when the remote is activated, brilliantly display the words, “Warning: Walking Pedestrians,” as well as walking silhouettes, which would be easily seen by the driver behind regardless of weather conditions.

The Pedestrian Warning System would provide a simple yet effective means of conveying to motorists the importance of keeping a diligent eye out for fellow travelers who are walking. A luminous display, these warning signs would point out to fellow motorists that everyone should be aware of the dangers faced by pedestrians. With strong yet clear words and pictures that stress the central theme, this product could convince people that it is better to consider pedestrian safety as well as their own over the temptation to engage in distractions, such as a cell phone. The Pedestrian Warning System would prove particularly useful to inexperienced teens and young drivers who often are tempted to chat on the phone or send text messages when operating a vehicle. Seeing one of these window beacons displayed on the car in front of them, these drivers may just think twice before grabbing their phones or becoming otherwise distracted.

Offering motorists a highly visible way in which to encourage better watchfulness when driving, this invaluable safety tool, the Pedestrian Warning System, should be well received by the general consumer populace, a sizable market potential.

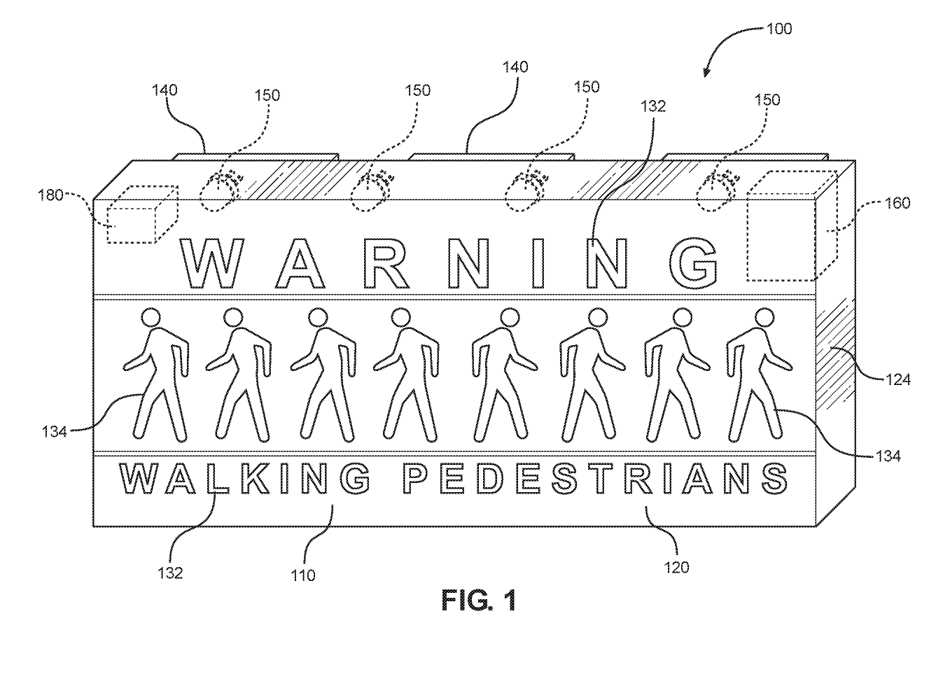

Referring to the drawings by numerals of reference there is shown in FIGS. 1-3, perspective views illustrating pedestrian warning system 100 for use with automobile 200 according to an embodiment of the present invention.

Pedestrian warning system 100 for use with automobile 200, comprising: electronic sign 110 and control member 400. Electronic sign 110 comprises: main body 120; at least one electric light 150; power source 160; and receiver 180. Main body 120 includes: front panel 130 and at least one attachment member 140. Wherein front panel 130 is formed of from a translucent material. Wherein main body 120 of electronic sign 110 is formed having dimensions including 4 inches in length, 6 inches in width, and ½ inch in depth. Wherein main body 120 of electronic sign 110 is formed from a plastic material.

Wherein front panel 130 includes indicia 132 thereon adapted to warn drivers of other automobiles that pedestrians may be present and to be cautious while driving. Wherein indicia 132 of front panel 130 includes “WARNING” and “WALKING PEDESTRIANS.” Wherein indicia 132 of front panel 130 includes at least one image 134 of pedestrians walking. Wherein front panel 130 is formed having a red color. Wherein front panel 130 includes reflective film thereon adapted to reflect light therefrom.

Wherein at least one attachment member 140 is adapted to releasably attach electronic sign 110 to a support surface of automobile 200. Wherein main body 120 forms interior volume 124. Wherein at least one electric light 150 is located within interior volume 124 and is adapted to illuminate front panel 130. Wherein power source 160 is electrically connected to at least one electric light 150 and is adapted to provide electric power to at least one electric light 150. Wherein at least one electric light 150 is formed as a light emitting diode. Wherein there are plurality of electric lights 150; and wherein plurality of electric lights are formed as a series of red and white color emitting light emitting diodes. Wherein receiver 180 is located within interior volume 124, is electrically connected to power source 160 and to at least one electric light 150 and is adapted to receive electronic signals from transmitter 430 of control member 400.

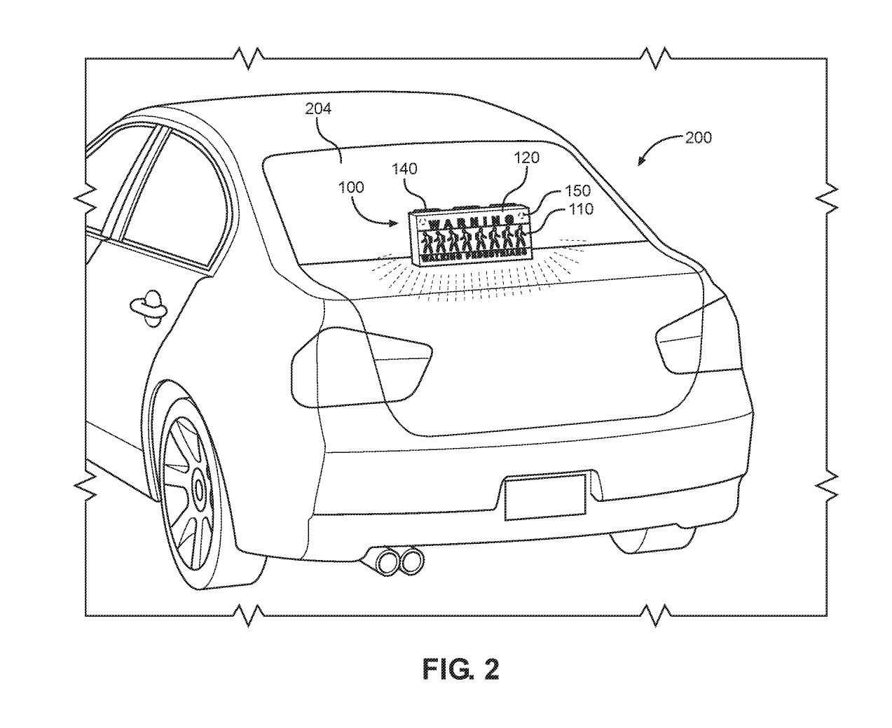

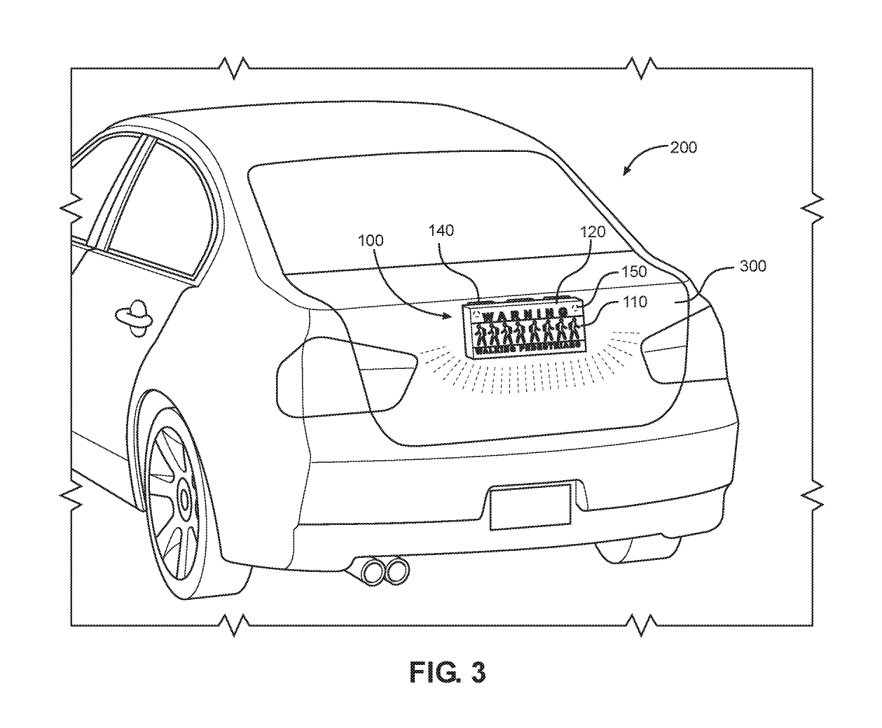

Control member 400 includes: main body 410 including at least one attachment member 420; transmitter 430; and power source 440. Wherein at least one attachment member 420 is adapted to releasably attach control member 410 to a support surface of automobile 200. Wherein main body 410 forms interior volume 414. Wherein transmitter 430 is located within interior volume 414 of main body 410 of control member 400 and is adapted to send electronic signals to receiver 180 of electronic sign 110. Wherein transmitter 430 is adapted to turn on and off at least one electric light 150 of electric sign 110. Wherein power source 440 is electrically connected to transmitter 430 and is adapted to provide electric power to transmitter 430. Wherein main body 410 of control member 400 is formed from a plastic material. Wherein control member 400 is adapted to be releasably connected to an interior surface of dashboard 450 of automobile 200 via attachment member 420 of main body 410 of control member 400.

Wherein pedestrian warning system 100 is adapted to allow a driver of an automobile to signal to other drivers of automobiles in the vicinity thereof that there may be pedestrians present in the vicinity thereof and to drive cautiously. Wherein electric sign 110 is adapted to be releasably connected to an interior surface of rear window 204 of automobile 200 via attachment member 140 of main body 120 of electric sign 110 as shown in FIG. 2. Wherein electric sign 110 is adapted to be releasably connected to tailgate 300 of automobile 200 via attachment member 140 of main body 120 of electric sign 110 as shown in FIG. 3.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A pedestrian warning system for use with an automobile, comprising:
an electronic sign comprising:
a main body including:
a front panel;
wherein said front panel is formed of from a translucent material; and
wherein said front panel includes indicia thereon adapted to warn drivers of other automobiles that pedestrians may be present and to be cautious while driving; and
at least one attachment member;
wherein said at least one attachment member is adapted to releasably attach said electronic sign to a support surface of said automobile;
wherein said main body forms an interior volume;
at least one electric light;
wherein said at least one electric light is located within said interior volume and is adapted to illuminate said front panel;
a power source;
wherein said power source is electrically connected to said at least one electric light and is adapted to provide electric power to said at least one electric light; and
a receiver;
wherein said receiver is located within said interior volume, is electrically connected to said power source and to said at least one electric light, and is adapted to receive electronic signals from a transmitter; and
a control member including:
a main body including:
at least one attachment member;
wherein said at least one attachment member is adapted to releasably attach said control member to a support surface of said automobile;
wherein said main body forms an interior volume;
a transmitter;
wherein said transmitter is located is located within said interior volume of said main body of said control member, and is adapted to send electronic signals to said receiver of said electronic sign; and
wherein said transmitter is adapted to turn on and off said at least one electric light of said electric sign; and
a power source;
wherein said power source is electrically connected to said transmitter and is adapted to provide electric power to said transmitter;
wherein said pedestrian warning system is adapted to allow a driver of an automobile to signal to other drivers of automobiles in the vicinity thereof that there may be pedestrians present in the vicinity thereof and to drive cautiously.

2. The pedestrian warning system of claim 1, wherein said front panel is formed having a red color.

3. The pedestrian warning system of claim 1, wherein said indicia of said front panel includes “WARNING” and “WALKING PEDESTRIANS”.

4. The pedestrian warning system of claim 1, wherein said indicia of said front panel includes at least one image of pedestrians walking.

5. The pedestrian warning system of claim 1, wherein said at least one electric light is formed as a light emitting diode.

6. The pedestrian warning system of claim 1, wherein there are a plurality of electric lights; and wherein said plurality of electric lights are formed as a series of red and white color emitting light emitting diodes.

7. The pedestrian warning system of claim 1, wherein said main body of said electronic sign is formed having dimensions including 4 inches in length, 6 inches in width, and ½ inch in depth.

8. The pedestrian warning system of claim 1, wherein said main body of said electronic sign is formed from a plastic material.

9. The pedestrian warning system of claim 8, wherein said main body of said control member is formed from a plastic material.

10. The pedestrian warning system of claim 1, wherein said front panel includes reflective film thereon adapted to reflect light therefrom.

11. The pedestrian warning system of claim 1, wherein said electric sign is adapted to be releasably connected to an interior surface of a rear window of an automobile via said attachment member of said main body of said electric sign.

12. The pedestrian warning system of claim 1, wherein said control member is adapted to be releasably connected to an interior surface of dashboard of an automobile via said attachment member of said main body of said control member.
